(19) United States
(12) Patent Application Publication
(10) Pub. No.: US 2018/0252667 A1
(43) Pub. Date: Sep. 6, 2018

(54) GAS SENSOR

(71) Applicants: NGK SPARK PLUG CO. LTD., Nagoya-shi (JP); SPIROSURE, INC., Pleasanton, CA (US)

(72) Inventors: Hiroyuki NISHIYAMA, Konan-shi (JP); Shinichiro KITO, Kasugai-shi (JP); Koji OMORI, Niwa-gun (JP); Solomon SSENYANGE, Fremont, CA (US); Ryan LEARD, Oakland, CA (US)

(73) Assignees: NGK SPARK PLUG CO. LTD., Nagoya-shi (JP); SPIROSURE, INC., Pleasanton, CA (US)

(21) Appl. No.: 15/448,704

(22) Filed: Mar. 3, 2017

(51) Int. Cl. G01N 27/406

(52) U.S. Cl. CPC G01N 27/4067

(57) ABSTRACT

A gas sensor including a plate-shaped base substrate and three or more mixed-potential-type sensor elements disposed at predetermined intervals on a main face of the base substrate and electrically connected in series. A single heat generation resistor for heating the mixed-potential-type sensor elements and a temperature sensor for measuring the temperature of the base substrate are embedded in the base substrate or disposed on a face of the base substrate opposite the main face. The heat generation resistor has a pattern which overlaps the mixed-potential-type sensor elements, and the maximum value of temperature differences among the mixed-potential-type sensor elements, produced as a result of energization and control of the mixed-potential-type sensor elements to a target temperature using the temperature sensor, falls within 5% of the target temperature.

### BACKGROUND OF THE INVENTION

### Field of the Invention

The present invention relates to a gas sensor for detecting the concentration of a gas component such as nitrogen oxide (NOx).

### Description of the Related Art

Environmental control, process control, health care, etc., require measurement of the concentration of NOx contained in a gas under measurement. In particular, diagnosis of asthma requires measurement of NOx contained in exhaled air at a very low concentration (several ppb to several hundreds ppb).

In view of these requirements, a technique of disposing a plurality of mixed-potential-type sensors on one side of a plate-shaped base substrate has been proposed, connecting them in series so as to increase detection sensitivity, and providing, on the opposite side of the base substrate, a heater (heat generation resistor) for heating the sensors to their operation temperature (see US Patent Application Publication No. 2015/0250408, incorporated herein by reference in its entirety, including but not limited to, FIGS. 4, 5A, 5B).

However, in the case where three or more mixed-potential-type sensors are disposed on the base substrate and are heated by the heater, the temperatures of the mixed-potential-type sensors near the center of the base substrate tend to become higher than a target temperature due to overheating. Also, the temperatures of the mixed-potential-type sensors on the outer circumferential side of the base substrate tend to become lower than the target temperature due to heat radiation.

When a mixed-potential-type sensor is overheated to a temperature higher than the target temperature, its durability deteriorates. When the temperature of the mixed-potential-type sensor becomes lower than the target temperature, the impedance of the sensor increases, and the gas detection sensitivity may deteriorate. Also, when the sensor temperature deviates from the target temperature, irrespective of whether the temperature deviates to a higher temperature or a lower temperature, the sensor is subject to the influence of a disruptive gas, and the accuracy in detecting a particular gas component may be lowered.

### SUMMARY OF THE INVENTION

In view of the above-described problems, an object of the present invention is to provide a gas sensor which includes three or more mixed-potential-type sensors provided on a base substrate and which decreases the temperature differences among the mixed-potential-type sensors, to thereby suppress deterioration of durability, gas detection sensitivity and detection accuracy.

The above object of the invention has been achieved by providing (1) a gas sensor which comprises a plate-shaped base substrate; three or more mixed-potential-type sensor elements which are disposed at predetermined intervals on a main face of the base substrate and each of which includes a solid electrolyte layer and a pair of electrodes provided on the solid electrolyte layer, the mixed-potential-type sensor elements being electrically connected in series; and a single heat generation resistor for heating the mixed-potential-type sensor elements and a temperature sensor for measuring a temperature of the base substrate, the heat generation resistor and the temperature sensor being embedded in the base substrate or being disposed on a face of the base substrate opposite the main face. The heat generation resistor has a pattern which overlaps the mixed-potential-type sensor elements when the base substrate is projected in a thickness direction thereof, and which is arranged such that the maximum value of temperature differences among the mixed-potential-type sensor elements, the temperature differences being produced as a result of energization and control of the mixed-potential-type sensor elements to a target temperature using the temperature sensor, fall within a range corresponding to 5% of the target temperature.

According to gas sensor (1), the temperature differences among the mixed-potential-type sensor elements decrease, the maximum value of the temperature differences falls within a range corresponding to 5% of the target temperature, and the temperatures of the mixed-potential-type sensor elements approach the target temperature. As a result, deterioration of the durability, gas sensitivity and detection accuracy of the mixed-potential-type sensor elements can be suppressed.

Also, the above-described configuration realizes uniform distribution of heat throughout the base substrate on which the heat generation resistor is disposed. Since consideration of the temperature distribution of the base substrate is not required when the temperature sensor necessary for controlling the energization of the heat generation resistor is disposed on the base substrate, the degree of freedom of determining the position of the temperature sensor (pattern formation) increases.

In a preferred embodiment (2) of the gas sensor (1) above, the heat generation resistor has a pattern such that the heat generation resistor extends along the base substrate and meanders by making a plurality of U-turns, and at least a portion of the heat generation resistor located on an outer circumferential side of the base substrate has a cross-sectional area smaller than that of another portion of the heat generation resistor located on an inner side of the base substrate with respect to the portion on the outer circumferential side.

According to the gas sensor (2), the electric resistance of the portion of the heat generation resistor located on the outer circumferential side of the base substrate becomes greater than the electric resistance of the portion of the heat generation resistor located on the inner side of the base substrate. Therefore, as a result of heating by the heat generation resistor, the temperature of the base substrate approaches the target temperature over the entire region. Accordingly, the temperature differences among the mixed-potential-type sensor elements decrease, and the temperatures of the mixed-potential-type sensor elements approach the target temperature.

In another preferred embodiment (3) of the gas sensor (1) above, the heat generation resistor may have a pattern such that the heat generation resistor extends along the base substrate and meanders by making a plurality of U-turns and has a plurality of straight portions extending parallel to one another, and spaces between the straight portions are adjusted such that an amount of heat generated on an outer circumferential side of the base substrate becomes greater than an amount of heat generated on an inner side of the base substrate.

According to the gas sensor (3), by adjusting the spaces between the straight portions of the heat generation resistor, the amount of heat generated on the outer circumferential side of the base substrate becomes greater than the amount of heat generated on the inner side of the base substrate. Therefore, as a result of heating by the heat generation resistor, the temperature of the base substrate approaches the target temperature over the entire region. Accordingly, the temperature differences among the mixed-potential-type sensor elements decrease, and the temperatures of the mixed-potential-type sensor elements approach the target temperature.

The present invention provides a gas sensor which includes three or more mixed-potential-type sensors disposed on a base substrate and which decreases the temperature differences among the mixed-potential-type sensors to thereby suppress deterioration of durability, gas detection sensitivity and detection accuracy.

### BRIEF DESCRIPTION OF THE DRAWINGS

FIG. 1 is an exploded perspective view of a gas sensor including mixed-potential-type sensor elements according to an embodiment of the present invention;

FIG. 2 is a bottom view of a sensor unit in which a plurality of mixed-potential-type sensor elements according to the embodiment of the present invention are connected in series;

FIG. 3 is a view showing the overlap between a heat generation resistor and the mixed-potential-type sensor elements when the sensor unit is projected in the thickness direction thereof;

FIG. 4 is a top view of the sensor unit showing the pattern of the heat generation resistor;

FIG. 5 is a top view showing a modification of the heat generation resistor;

FIG. 6 is a top view of a heat generation resistor of a comparative example;

FIG. 7 is a pair of images showing the temperature distribution of the mixed-potential-type sensor elements of a gas sensor of an example; and

FIG. 8 is a pair of images showing the temperature distribution of the mixed-potential-type sensor elements of a gas sensor of a comparative example.

### DESCRIPTION OF THE PREFERRED EMBODIMENT

The present invention will now be described in detail with reference to the drawings. However, the present invention should be construed as being limited thereto.

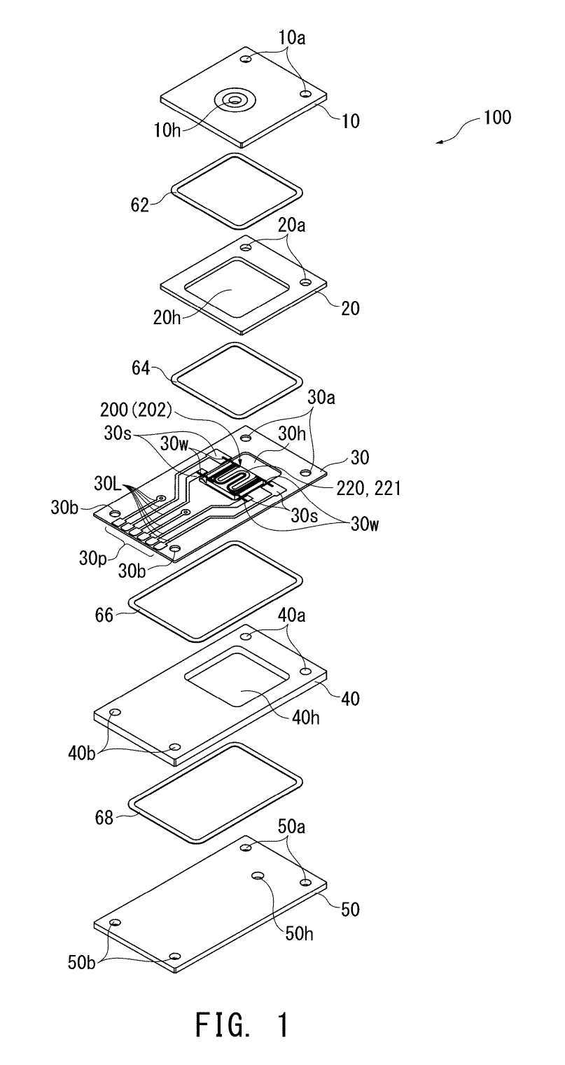

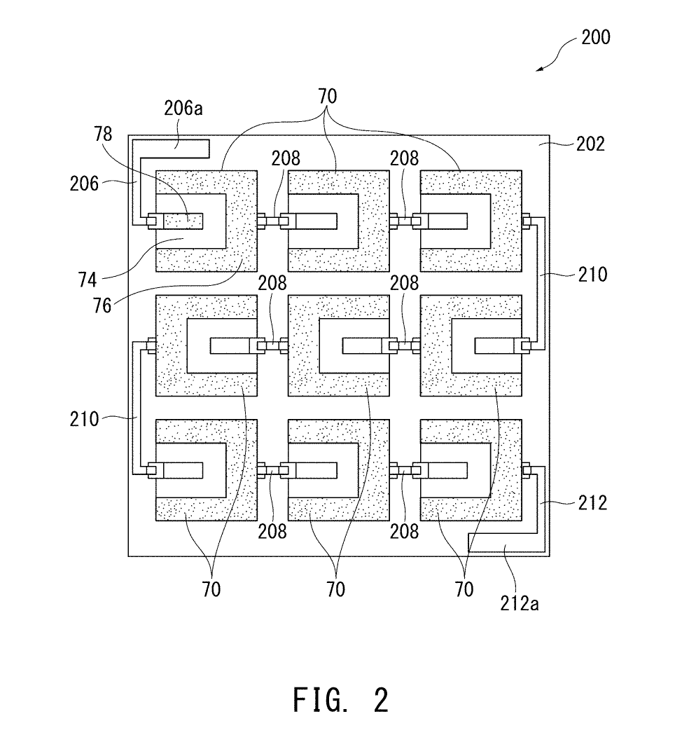

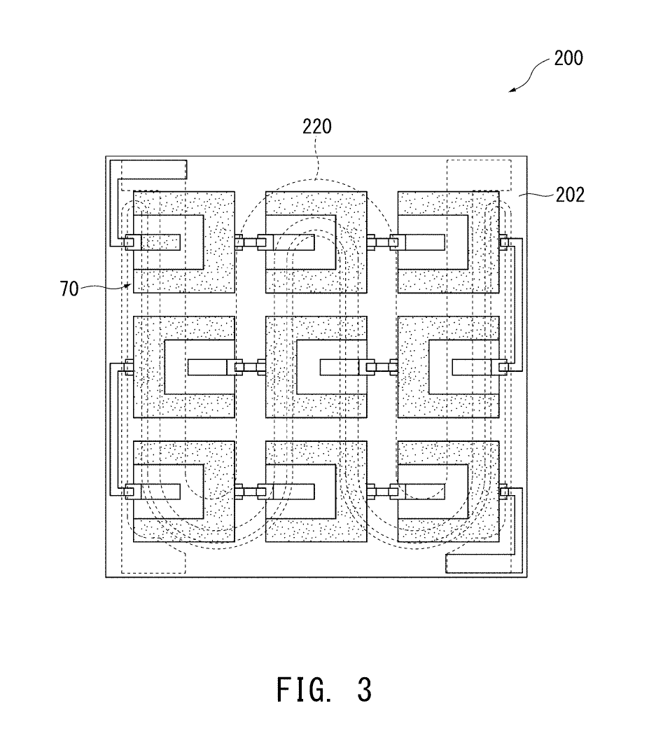

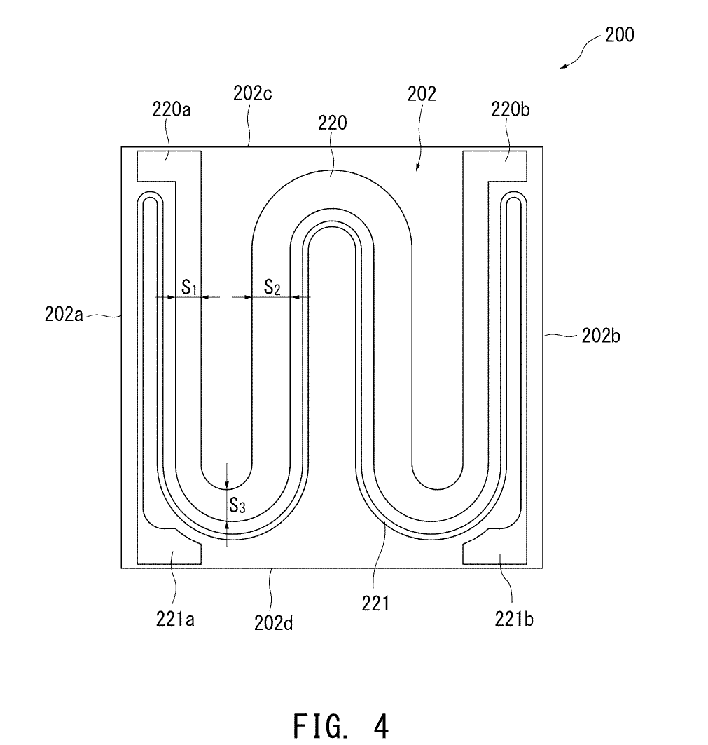

FIG. 1 is an exploded perspective view of a gas sensor (NOx sensor) 100 which includes mixed-potential-type sensor elements 70 according to an embodiment of the present invention. FIG. 2 is a bottom view of a sensor unit 200 in which the plurality of mixed-potential-type sensor elements 70 are connected in series. FIG. 3 is a view showing the overlap between a heat generation resistor 220 and the mixed-potential-type sensor elements 70 when the sensor unit 200 is projected in the thickness direction thereof. FIG. 4 is a top view of the sensor unit 200 showing the pattern of the heat generation resistor 220. Notably, the upper side of FIG. 1 will be referred to as “upper side” and the lower side of FIG. 1 will be referred to as “lower side.”

As shown in FIG. 1, the gas sensor 100 includes the sensor unit 200, a ceramic wiring board 30 fixedly suspending the sensor unit 200, a rectangular-frame-shaped first spacer 20 disposed on the upper side of the ceramic wiring board 30, a cover 10 disposed on the upper side of the spacer 20, a rectangular-frame-shaped second spacer 40 disposed on the lower side of the ceramic wiring board 30, and a base 50 disposed on the lower side of the second spacer 40.

The sensor unit 200 includes a base substrate 202 and has a generally rectangular plate-like shape. As shown in FIG. 4, a heat regeneration resistor 220 and a temperature sensor 221 are disposed on the upper surface of the base substrate 202. Meanwhile, the plurality of mixed-potential-type sensor elements 70 shown in FIG. 2 are disposed on the lower surface of the base substrate 202 and are connected in series. The sensor unit 200 measures the concentration of NOx contained in a gas under measurement (e.g., exhaled air).

As shown in FIG. 4, the heat regeneration resistor 220 disposed on the upper surface of the base substrate 202 has a meandering pattern; i.e., extending while making U-turns at the upper side and lower side of the base substrate 202. Conducting pads 220a and 220b which form opposite ends of the heat regeneration resistor 220 are formed on the upper surface of the sensor unit 200 (the base substrate 202) to be located near opposite ends of the upper side of the sensor unit 200. The temperature sensor 221 extends while meandering along the heat regeneration resistor 220 on the upper surface of the sensor unit 200. Conducting pads 221a and 221b which form opposite ends of the temperature sensor 221 are formed on the upper surface of the sensor unit 200 (the base substrate 202) to be located near opposite ends of the lower side of the sensor unit 200.

The lower surface of the base substrate 202 corresponds to a “main face” of the invention, and the upper surface thereof corresponds to a “face opposite the main face” of the invention.

The ceramic wiring board 30 has an oblong shape and has a rectangular opening 30h on one end side in the longitudinal direction thereof. Six lead traces 30L are formed on the front surface of the ceramic wiring board 30, and two lead traces (not shown) are formed on the back surface of the ceramic wiring board 30. The lead traces 30L are connected to conducting pads 30p on the side opposite the opening 30h.

The sensor unit 200 is accommodated in the opening 30h. Four conducting members 30w extend across the left-hand and right-hand sides of the sensor unit 200, and are joined to the conducting pads 220a, 220b, 221a, and 221b on the upper surface side of the sensor unit 200 (on the side where the heat regeneration resistor 220 and the temperature sensor 221 are provided) and to four front-surface-side element peripheral pads 30s formed on the front surface of the ceramic wiring board 30. As a result, the sensor unit 200 is fixedly suspended within the opening 30h of the ceramic wiring board 30.

Meanwhile, as shown in FIG. 2, on the lower surface side of the sensor unit 200 (the side where the mixed-potential-type sensor elements 70 are provided), end portions 206a and 212a of lead traces 206 and 212 constitute a pair of input/output terminals (electrode pads). Although not illustrated, two back-surface-side element peripheral pads surrounding the opening 30h and the end portions 206a and 212a are joined by conducting members.

Notably, as shown in FIG. 1, on the upper surface side of the sensor unit 200, of the inner ends of the six lead traces 30L, the inner ends of the leftmost lead trace and the fourth lead trace as counted from the left-hand side are not connected to the front-surface-side element peripheral pads 30s. Rather, these two inner pads are connected to two through hole conductors at a location near the center of the ceramic wiring board 30. The two lead traces 30L connected to the through hole conductors are electrically connected, via the through hole conductors, to two lead traces (not shown) formed on the back surface of the ceramic wiring board 30 and connected, at their inner ends, to the back-surface-side element peripheral pads. Electrical signals output from the mixed-potential-type sensor elements 70 are output from the gas sensor through the back-surface-side element peripheral pads, the through hole conductors, and the conducting pads 30p.

In this manner, the electrical signals output from the mixed-potential-type sensor elements 70 and the temperature sensor 221 are output from the gas sensor through the conducting pads 30p, and the heat regeneration resistor 220 is energized for heat generation by electric power externally supplied through the conducting pads 30p.

The first spacer 20 has a square shape and has a rectangular opening 20h which overlaps the opening 30h and is larger than the opening 30h.

The cover 10 has a square shape and has the same dimensions as the first spacer 20. A gas discharge hole 10h is formed in a portion of the cover 10 which faces the opening 20h.

The second spacer 40 has an oblong shape and has the same dimensions as the ceramic wiring board 30. The second spacer 40 has a rectangular opening 40h on the same side as the opening 30h with respect to the longitudinal direction of the ceramic wiring board 30. The opening 40h overlaps the opening 30h and is larger than the opening 30h.

The base 50 has an oblong shape and has the same dimensions as the ceramic wiring board 30. A gas introduction hole 50h is formed in a portion of the base 50 which faces the opening 40h.

The ceramic wiring board 30, the first spacer 20, the cover 10, the second spacer 40 and the base 50 may be formed of a ceramic material such as alumina or mullite.

Square seals 64 and 62 are disposed between the ceramic wiring board 30 and the first spacer 20 and between the first spacer 20 and the cover 10, respectively, to surround the opening 20h. Similarly, oblong seals 66 and 68 are disposed between the ceramic wiring board 30 and the second spacer 40 and between the second spacer 40 and the base 50, respectively, to surround the opening 40h.

Notably, the seals 66 and 68 extend toward the conducting pads 30p in the longitudinal direction of the ceramic wiring board 30 over a distance greater than that of the seals 64 and 62. The seals 62 to 68 are formed of glass or inorganic adhesive.

In the present embodiment, the cover 10, the first spacer 20, the ceramic wiring board 30, the second spacer 40, and the base 50 are gastightly bonded and stacked together via the seals 62 to 68.

The ceramic wiring board 30 has positioning holes 30a provided at opposite ends of an end portion thereof located on the opening 30h side with respect to the longitudinal direction. Similarly, the ceramic wiring board 30 has positioning holes 30b provided at opposite ends of an end portion thereof located on the side of the conducting pads 30p.

The first spacer 20 and the cover 10 have positioning holes 20a and 10a, respectively, which are provided at the same positions as the positioning holes 30a.

Similarly, the second spacer 40 has positioning holes 40a and 40b provided at the same positions as the positioning holes 30a and 30b, respectively, and the base 50 has positioning holes 50a and 50b provided at the same positions as the positioning holes 30a and 30b, respectively.

The cover 10, the first spacer 20, the ceramic wiring board 30, the second spacer 40, and the base 50 (these members are also referred to herein as “the respective members”) are stacked in this order, jigs (guide pins) are passed through the positioning holes 10a to 50a, 40b and 50b to thereby position the respective members, and the respective members are bonded together through use of the seals 62 to 68, whereby the gas sensor 100 is formed.

The gas under measurement introduced through the gas introduction hole 50h flows through an internal space formed by the opening 40h, comes into contact with the mixed-potential-type sensor elements 70 of the sensor unit 200, by which the NOx concentration is measured, flows through an internal space formed by the opening 20h, and is discharged to the outside through the gas discharge hole 10h.

Next, the structures of the sensor unit 200 and the mixed-potential-type sensor elements 70 will be described with reference to FIG. 2.

As shown in FIG. 2, the sensor unit 200 includes a generally rectangular plate-shaped base substrate 202. The plurality (9 in FIG. 2) of mixed-potential-type sensor elements 70 each including a solid electrolyte layer 74 and a pair of electrodes 76 and 78 provided thereon are arrayed at predetermined intervals on the lower surface of the base substrate 202. Notably, the mixed-potential-type sensor elements 70 are disposed on the lower surface of the base substrate 202 to form a 3×3 matrix; i.e., such that each row extending in the left-right direction of FIG. 2 includes three mixed-potential-type sensor elements 70 and each column extending in the vertical direction includes three mixed-potential-type sensor elements 70.

The electrode 78 serves as a reference electrode which has a catalytic activity for converting NO₂ to NO. The electrode 76 does not have such a catalytic activity for converting NO₂ to NO and functions as a detection electrode.

The mixed-potential-type sensor elements 70 are connected in series by lead traces 206, 208, 210 and 212. Of these traces, the lead traces 206 and 212 have end portions 206a and 212a which serve as a pair of input/output terminals (electrode pads) which are the start and end points of the current path of the series circuit.

The heat regeneration resistor 220 (see FIG. 4) provided on the upper surface of the base substrate 202 heats the mixed-potential-type sensor elements 70 to their operation temperature.

The base substrate 202 may be formed of a ceramic material such as alumina or mullite. The heat regeneration resistor 220 and the temperature sensor 221 may be formed of a metal such as platinum.

As shown in FIG. 3, when the heat generation resistor 220 of the sensor unit 200 is projected in the thickness direction of the base substrate 202, the pattern of the heat generation resistor 220 at least partially overlaps each of the mixed-potential-type sensor elements 70.

As a result, each of the mixed-potential-type sensor elements 70 is heated by the heat generation resistor 220.

Next, the structures of the heat generation resistor 220 and the temperature sensor 221 will be described with reference to FIG. 4.

As shown in FIG. 4, the heat generation resistor 220 has a pattern such that left-hand and right-hand halves of the heat generation resistor 220 extend toward the lower side of FIG. 4, respectively, from the conducting pads 220a and 220b disposed near the opposite ends of the upper side 202c of the base substrate 202, make U-turns toward the inner side of the base substrate 202 in the vicinity of the lower side 202d of the base substrate 202, extend upward, curve inward in the vicinity of the upper side 202c, and join together. Namely, the heat generation resistor 220 has three U-turn portions.

Left-hand and right-hand halves of the temperature sensor 221 extend toward the upper side of FIG. 4 from the conducting pads 221a and 221b disposed near the opposite ends of the lower side 202d of the base substrate 202, make U-turns toward the inner side of the base substrate 202 in the vicinity of the upper side 202c, extend downward along the outer side of the heat generation resistor 220, make U-turns toward the inner side in the vicinity of the lower side 202d, extend upward along the inner side of the heat generation resistor 220, curve inward in the vicinity of the upper side 202c, and join together.

The cross-sectional area of the temperature sensor 221 is smaller than that of the heat generation resistor 220. The temperature sensor 221 measures the temperature of the base substrate 202 and outputs an output signal to an external circuit. The heat generation resistor 220 is energized and controlled by the unillustrated external circuit based on the output of the temperature sensor 221.

The heat generation resistor 220 has a pattern determined such that the maximum value of temperature differences among the mixed-potential-type sensor elements 70, which differences are produced as a result of energization and control of the heat generation resistor 220 based on the temperature detected by the temperature sensor 221, falls within a range corresponding to 5% of a target temperature of the heat generation resistor 220.

Specifically, as to portions of the heat generation resistor 220 which extend along the two sides 202a and 202b of the base substrate 202 located on the left and right sides in FIG. 4, the cross-sectional area 51 of a first portion located on the outer circumferential side of the base substrate 202 is smaller than the cross-sectional area S2 of a second portion located on the inner side of the base substrate 202 with respect to the first portion.

Similarly, a third portion of the heat generation resistor 220, which portion is located on the outer circumferential side of the base substrate 202 as viewed in a direction orthogonal to the two sides 202c and 202d of the base substrate 202 located on the upper and lower sides in FIG. 4, has a cross-sectional area S3 which is smaller than the cross-sectional area S2 of the second portion of the heat generation resistor 220 located on the inner side of the base substrate 202 with respect to the third portion.

In the present embodiment, the thickness of the heat generation resistor 220 is fixed (maintained constant), and the width (line width) of the heat generation resistor 220 changes along the longitudinal direction thereof whereby the cross-sectional area S1 is made smaller than the cross-sectional area S2 and the cross-sectional area S3 is made smaller than the cross-sectional area S2. The heat generation resistor 220 may also be formed such that the cross-sectional areas S1 to S3 satisfy the above-descried relations by changing the thickness along the longitudinal direction of the heat generation resistor 220 while maintaining the line width of the heat generation resistor 220 constant.

As a result, on the base substrate 202, the electric resistances (heat generation amounts) of the portions of the heat generation resistor 220 located on the outer circumferential side of the base substrate 202 are greater than the electric resistances (heat generation amounts) of the portions of the heat generation resistor 220 located on the inner side of the base substrate 202.

Therefore, the heated temperatures of the mixed-potential-type sensor elements 70 which are located on the outer circumferential side of the base substrate 202 and which are likely to cool to lower temperatures due to heat radiation approach the target temperatures. Also, the heated temperatures of the mixed-potential-type sensor elements 70 which are located closer to the center of the base substrate 202, from which heat escapes less, and which are likely to be overheated, approach the target temperatures. As a result, the temperature differences among the mixed-potential-type sensor elements 70 decease. In the gas sensor 100 of the present embodiment, since the maximum value of temperature differences among the mixed-potential-type sensor elements 70 falls within a range corresponding to 5% of the target temperature to which the heat generation resistor 220 is controlled through use of the temperature sensor 221, deterioration of the durability, gas sensitivity, and detection accuracy of the mixed-potential-type sensor elements 70 is suppressed.

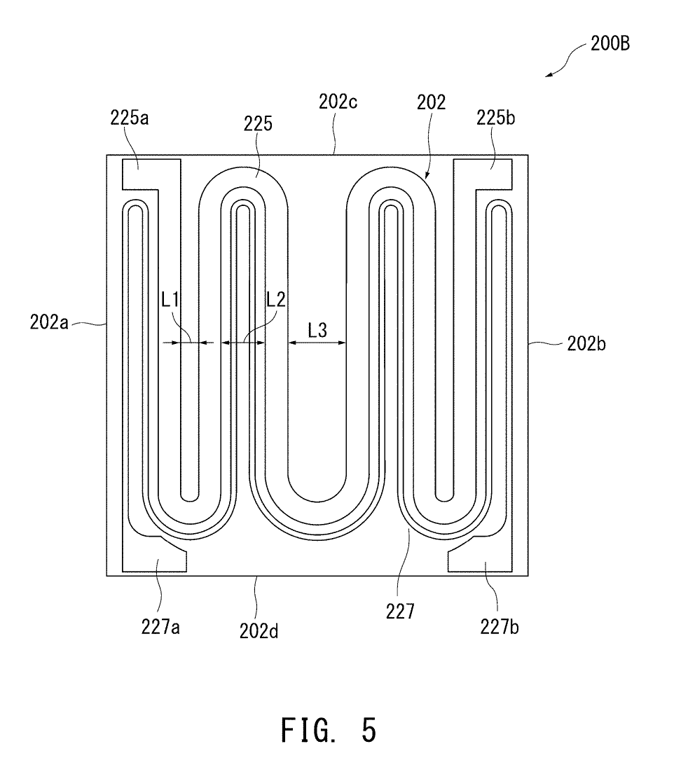

FIG. 5 shows a modification of the heat generation resistor which is denoted by reference numeral 225.

As shown in FIG. 5, the heat generation resistor 225 has a pattern such that left-hand and right-hand halves of the heat generation resistor 225 extend toward the lower side of FIG. 5, respectively, from conducting pads 225a and 225b disposed near opposite ends of the upper side 202c of the base substrate 202, make U-turns toward the inner side of the base substrate 202 in the vicinity of the lower side 202d of the base substrate 202, and extend upward. Further, the left-hand and right-hand halves of the heat generation resistor 225 make U-turns toward the inner side in the vicinity of the upper side 202c, extend downward, curve inward in the vicinity of the lower side 202d, and join together. Namely, the heat generation resistor 225 has five U-turn portions.

Left-hand and right-hand halves of a temperature sensor 227 extend toward the upper side of FIG. 5 from conducting pads 227a and 227b disposed near the opposite ends of the lower side 202d of the base substrate 202, make U-turns toward the inner side of the base substrate 202 in the vicinity of the upper side 202c, extend downward along the outer side of the heat generation resistor 225, make U-turns toward the inner side in the vicinity of the lower side 202d, extend upward along the inner side of the heat generation resistor 225, make U-turns toward the inner side in the vicinity of the upper side 202c, extend downward along the outer side of the heat generation resistor 225, curve inward in the vicinity of the lower side 202d, and join together.

Line spaces L1, L2, and L3 between straight portions of the heat generation resistor 225 located adjacent to one another, which line spaces are located in this order from the outer circumferential side toward the inner side of the base substrate 202 as viewed in a direction orthogonal to the two sides 202a and 202b of the base substrate 202 located on the left and right sides in FIG. 5, satisfy a relation of L1<L2<L3. Namely, the line space between the straight portions of the heat generation resistor 225 on the outer circumferential side of the base substrate 202 is smaller than the line space between the straight portions located on the inner side of the base substrate 202.

In this case as well, on the base substrate 202, the respective heat generation amounts of the portions of the heat generation resistor 225 located on the outer circumferential side of the base substrate 202 become greater than the respective heat generation amounts of the portions of the heat generation resistor 225 located on the inner side of the base substrate 202. Accordingly, by adjusting the line spaces L1, L2 and L3, the heat generation amounts of the respective portions of the heat generation resistor 225 can be adjusted such that the maximum value of temperature difference among the mixed-potential-type sensor elements 70 falls within a range corresponding to 5% of the target temperature to which the heat generation resistor 225 is controlled through use of the temperature sensor.

Notably, in the example of FIG. 5, the cross-sectional area (width) of the heat generation resistor 225 is constant over the entire length thereof Also, the pattern of the temperature sensor 227 changes shape so as to extend along the heat generation resistor 225.

The present invention is not limited to the above-described embodiment and encompasses various modifications and equivalents falling within the spirit and scope of the invention.

For example, the shape of the pattern of the heat generation resistor is not limited to that employed in the above-described embodiment.

The shapes of the solid electrolyte layer and the porous electrodes, the shape and number of the mixed-potential-type sensor elements, etc., are not limited to those of the above-described embodiment. The position of the heat generation resistor is not limited to the back surface of the base substrate and may be embedded in the base substrate. Further, the gas sensor of the present invention is not limited to an NOx sensor, and the present invention can be applied to other types of sensors, such as an ammonia sensor, so long as they have mixed-potential-type sensor elements.

### Example 1

A sensor unit 200 including a heat generation resistor 220 having the pattern shown in FIG. 4 was manufactured as an example, and assembled within the gas sensor 100 of FIG. 1. The heat generation resistor 220 was formed by printing a Pt paste on a green base substrate 202 of alumina followed by firing, and satisfied the above-described relations of the cross-sectional areas S1 to S3.

In this gas sensor 100, the heat generation resistor 220 was energized and controlled using the temperature sensor 221, with the target temperature set to 400° C., and the temperature of the mixed-potential-type sensor element 70 located at the center of the base substrate 202 and the temperature of the mixed-potential-type sensor element 70 located at the lower right corner of the base substrate 202 in FIG. 2 were measured.

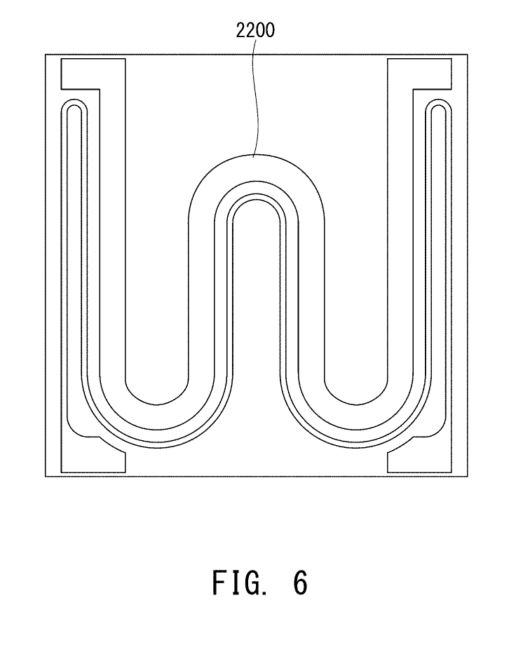

A sensor unit 200 including a heat generation resistor 2200 having the pattern shown in FIG. 6 was manufactured as a comparative example, and assembled within the gas sensor 100 of FIG. 1. The heat generation resistor 2200 was energized and controlled in a similar manner, with the target temperature set to 400° C., and the temperatures of the mixed-potential-type sensor elements 70 were measured.

Notably, the heat generation resistor 2200 of FIG. 6 differs from the heat generation resistor 220 of FIG. 4 in that the heat generation resistor 2200 of FIG. 6 has a constant cross-sectional area (is formed into a pattern having a cross-sectional area equal to the cross-sectional area Si of the example over the entire length thereof), and the straight portions of the heat generation resistor 2200 located at the center of the base substrate 202 extend upward over a shorter length.

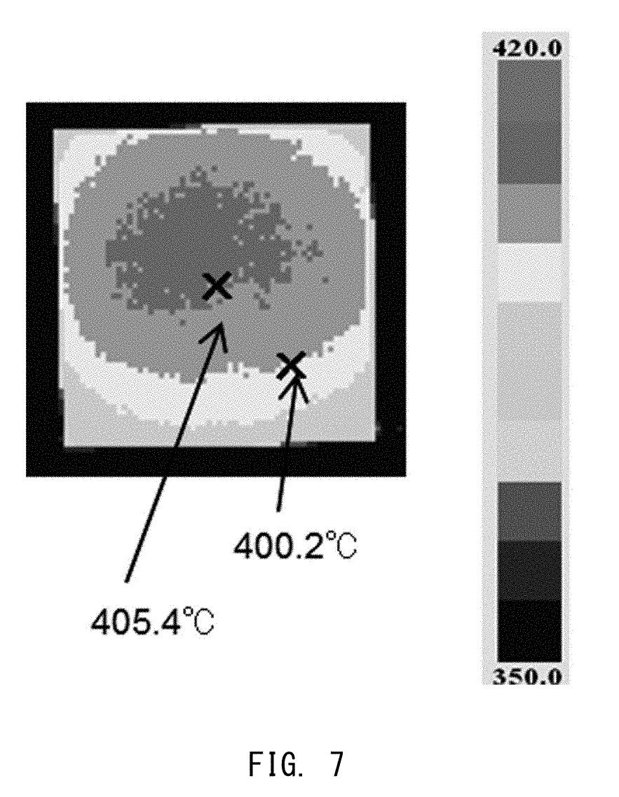

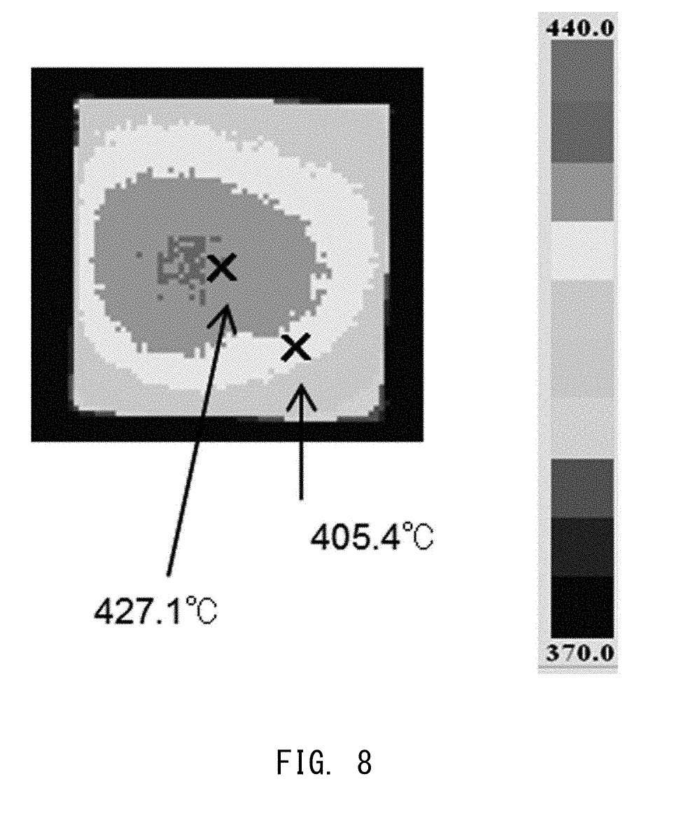

FIGS. 7 and 8 show the results that were obtained.

As shown in FIG. 7, in the case of the example, the temperature of the mixed-potential-type sensor element 70 located at the center and having the highest temperature was 405.4° C., and the temperature of the mixed-potential-type sensor element 70 located at the lower right corner and having the lowest temperature was 400.2° C. Therefore, in the case of the example, the maximum value of temperature differences among the mixed-potential-type sensor elements 70 fell within the range corresponding to 5% of the target temperature (400° C.) to which the heat generation resistor 220 is controlled using the temperature sensor 221 (the temperatures of the mixed-potential-type sensor elements 70 fell within the range of 380 to 420° C.).

On the other hand, as shown in FIG. 8, in the case of the comparative example, the temperature of the mixed-potential-type sensor element 70 located at the center and having the highest temperature was 427.1° C., and the temperature of the mixed-potential-type sensor element 70 located at the lower right corner and having the lowest temperature was 405.4° C. Therefore, in the case of the comparative example, the maximum value of temperature differences among the mixed-potential-type sensor elements 70 exceeded 5% of the target temperature (400° C.) (the temperature of the mixed-potential-type sensor element 70 at the center exceeded 420° C.).

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

What is claimed is:

1. A gas sensor comprising:
a plate-shaped base substrate;
three or more mixed-potential-type sensor elements which are disposed at predetermined intervals on a main face of the base substrate and each of which includes a solid electrolyte layer and a pair of electrodes provided on the solid electrolyte layer, the mixed-potential-type sensor elements being electrically connected in series; and
a single heat generation resistor for heating the mixed-potential-type sensor elements and a temperature sensor for measuring a temperature of the base substrate, the heat generation resistor and the temperature sensor being embedded in the base substrate or being disposed on a face of the base substrate opposite the main face, wherein
the heat generation resistor has a pattern which overlaps the mixed-potential-type sensor elements when the base substrate is projected in a thickness direction thereof, and which is arranged such that the maximum value of temperature differences among the mixed-potential-type sensor elements, the temperature differences being produced as a result of energization and control of the mixed-potential-type sensor elements to a target temperature using the temperature sensor, fall within a range corresponding to 5% of the target temperature.

2. The gas sensor as claimed in claim 1, wherein the heat generation resistor has a pattern such that the heat generation resistor extends along the base substrate and meanders by making a plurality of U-turns, and at least a portion of the heat generation resistor located on an outer circumferential side of the base substrate has a cross-sectional area smaller than that of another portion of the heat generation resistor located on an inner side of the base substrate with respect to the portion on the outer circumferential side.

3. The gas sensor as claimed in claim 1, wherein the heat generation resistor has a pattern such that the heat generation resistor extends along the base substrate and meanders by making a plurality of U-turns, and has a plurality of straight portions extending parallel to one another, and spaces between the straight portions are adjusted such that an amount of heat generated on an outer circumferential side of the base substrate is greater than an amount of heat generated on an inner side of the base substrate.

4. The gas sensor as claimed in claim 1, wherein the target temperature is in degrees Celsius.

5. The gas sensor as claimed in claim 1, wherein the target temperature is in the vicinity of the operating temperature of the gas sensor.
